(19) United States
(12) Patent Application Publication
(10) Pub. No.: US 2024/0233586 A1
(43) Pub. Date: Jul. 11, 2024

(54) Temporary Biodegradable Outdoor Display Objects

(71) Applicant: Green IP, LLC, Green Cove Springs, FL (US)

(72) Inventors: Robert Neal Alfred Hawkinson, Green Cove Springs, FL (US); Kelvin T. Okamoto, Carmel, IN (US)

(21) Appl. No.: 18/405,701

(22) Filed: Jan. 5, 2024

Related U.S. Application Data
(60) Provisional application No. 63/479,390, filed on Jan. 11, 2023.

(51) Int. Cl. G09F 17/00

(52) U.S. Cl. CPC G09F 17/00; G09F 2017/0033

(57) ABSTRACT

Temporary biodegradable outdoor display objects including marker flags, yard signs, boundary tapes, and grass depth gauges. The objects are all formed from a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.

### CROSS REFERENCE TO RELATED PATENT APPLICATIONS

This invention claims priority from U.S. Provisional Patent Application No. 63/479,390, filed Jan. 11, 2023, which is hereby incorporated by reference.

### FIELD OF THE INVENTION

This invention relates to temporary biodegradable outdoor display objects such as marker flags, yard signs, boundary tapes, and grass depth gauges.

### BACKGROUND OF THE INVENTION

Temporary outdoor display objects such as marker flags, yard signs, boundary tapes, and grass depth gauges are typically manufactured from materials that are not biodegradable. Consequently, once the temporary use of the outdoor display objects has ended, the outdoor display objects often remain creating unsightly trash and debris. Because some of the outdoor display objects employ plastic materials that are not biodegradable, such plastic materials can end up polluting streams, rivers, lakes, and the ocean.

### SUMMARY OF THE INVENTION

The present invention alleviates the problem of pollution created by temporary outdoor display objects. Such as marker flags, yard signs, boundary tapes, and grass depth gauges the present invention are made entirely of a biodegradable plastic material.

Marker flags are commonly used to mark the location of underground utilities including electrical wiring, gas lines, and water lines. Such marker flags can also be used to layout landscaping features. The marker flag of the present invention includes a biodegradable stake with a colored biodegradable plastic sheet attached thereto. The plastic sheet is attached to the stake either by heat welding or by an adhesive. The stake of the marker flag is pushed into the ground at the desired location.

Yard signs provide information to passersby and include for sale signs, political signs, warning signs, and announcements. A yard sign of the present invention includes one or more biodegradable stakes with biodegradable plastic sign sheet extending from the one or more stakes. The sign sheet is attached to the one or more stakes either by heat welding or by an adhesive. The one or more stakes of the yard sign are pushed into the ground in order to support the yard sign sheet.

Boundary or flagging tapes are used to indicate the boundary of an area such as police crime scene tapes, other emergency scene tapes, or survey boundaries. Flagging tapes are used to identify the location of a feature such as the location of a survey pin. The tapes of the present invention are formed of extruded printable biodegradable plastic.

A grass depth gauge of the present invention is implemented by a biodegradable plastic stake. The stake has an anchor at its lower end and a ground stop to assure that the stake is inserted in the ground to a predetermined depth. In one embodiment, the portion of the stake above ground has indices indicating the length of the stake above the ground. In another embodiment, a paper sleeve with indices is placed over the stake to indicate the length above the ground. When a mower is run over the depth gauge, the depth gauge and/or the paper sleeve is cut off, and the remaining indices inform yard maintenance personnel of the length of grass that the mower has left standing.

Further objects, features and advantages will become apparent upon consideration of the following detailed description of the invention when taken in conjunction with the drawings and the appended claims.

### BRIEF DESCRIPTION OF THE DRAWINGS

FIG. 1 is a schematic side elevation view of a marker flag in accordance with the present invention.

FIG. 2 is a schematic side elevation view of a first embodiment of a yard sign in accordance with the present invention.

FIG. 3 is a schematic side elevation view of a second embodiment of a yard sign in accordance with the present invention.

FIG. 4 is a schematic top plan view of a boundary or flagging tape in accordance with the present invention.

FIG. 5 is a schematic side elevation view of the boundary or flagging tape in accordance with the present invention.

FIG. 6 is a schematic side elevation view of a first embodiment of a depth gauge in accordance with the present invention.

FIG. 7 is a schematic side elevation view of a second embodiment of the depth gauge in accordance with the present invention.

### DETAILED DESCRIPTION OF THE PREFERRED EMBODIMENTS

Marker flag 10, yard signs 20 and 30, boundary tape 60, and depth gauges 40 and 140 are all constructed in their entirety of a biodegradable plastic material. The formulation of the plastic material for the biodegradable the marker flag 10, the yard signs 20 and 30, the boundary tape 60, and the depth gauges 40 and 140 is a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer (hereinafter the “bioplastic material”). The bioplastic material is described in detail in U.S. Pat. No. 11,608,436, issued Mar. 21, 2023, which is incorporated herein by reference in its entirety.

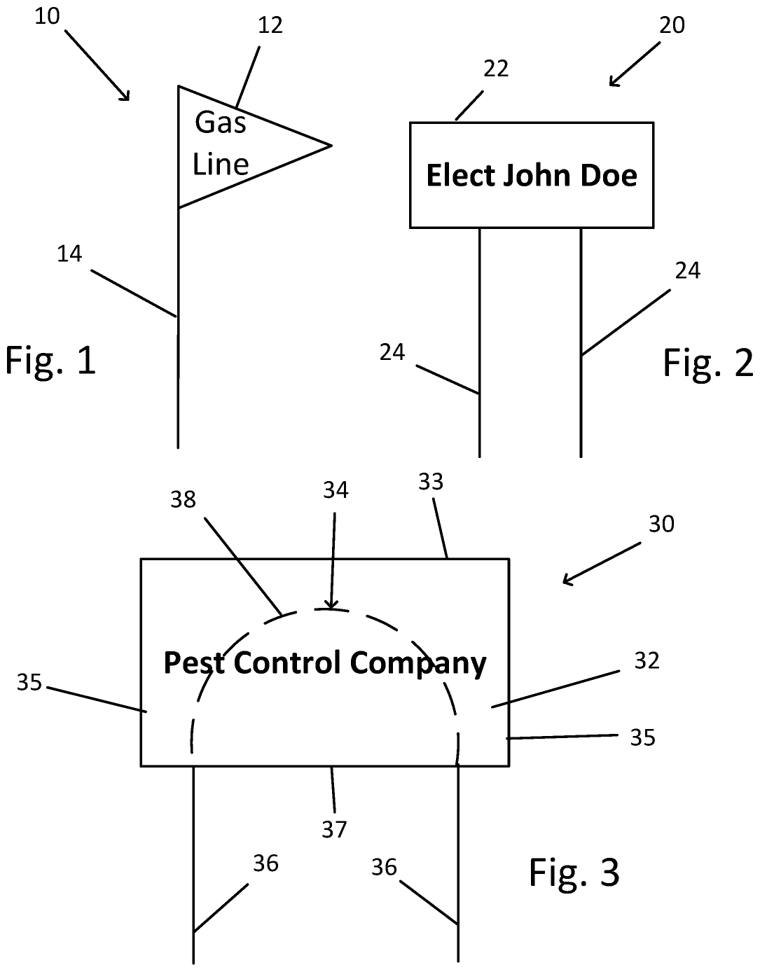

FIG. 1 shows marker flag 10 that includes a biodegradable stake 14 with a colored biodegradable plastic flag sheet 12 attached thereto. The stake 14 is created by extruding the bioplastic material to produce the stake 14 of the proper diameter and length for its intended purpose. The flag sheet 12 is created by casting the bioplastic material into a sheet. The flag sheet 12 is connected to the stake 14 either by heat welding or by the use of an adhesive. Once the marker flag 10 has been constructed, the stake 14 of the marker flag 10 is pushed into the ground at the desired location.

FIG. 2 shows first embodiment of a yard sign 20 that includes two biodegradable stakes 24 with a biodegradable sign sheet 22 extending between the stakes 24. The stakes 24 are created by extruding the bioplastic material to produce the stakes 24 of the proper diameters and lengths for their intended purpose. The sign sheet 22 is formed from a sheet of the bioplastic material and is of a size and thickness for its intended purpose. The sign sheet 22 is attached to the stakes 24 either by heat welding or by an adhesive. The stakes 24 of the yard sign 20 are pushed into the ground in order to support the sign sheet 22 of yard sign 20.

FIG. 3 shows a second embodiment of a yard sign 30. The yard sign 30 includes a bent biodegradable stake 34 and a biodegradable sleeve 32. The bent stake 34 is created by first extruding the bioplastic material to produce a straight rod of the proper length for its purpose. The rod is then heated and bent into a U-shape with legs 36 and a curved section 38. The sign portion of the yard sign 30 is a flat two-sided sleeve 32 that is closed on the 33 top and sides 35 but open on the bottom 37. Sleeve 32 slips over the bent stake 34 and is thereby supported by the bent stake 34.

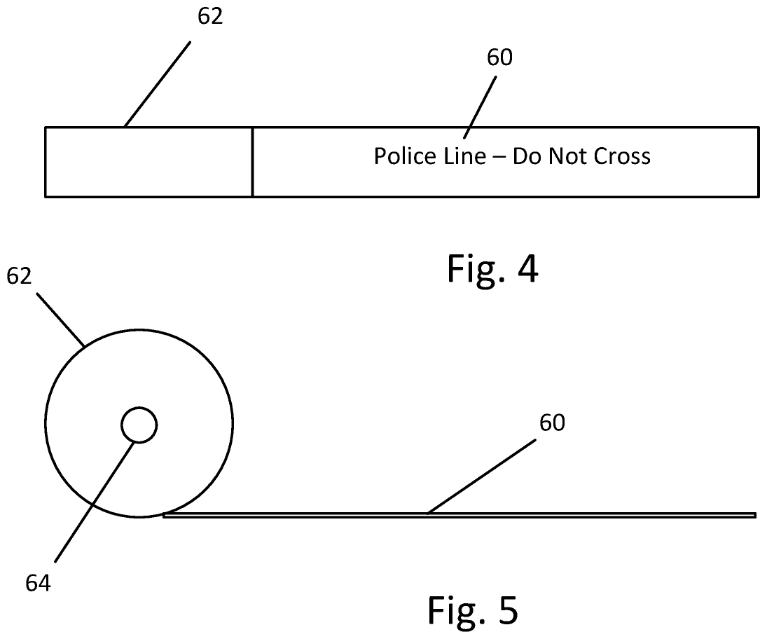

FIGS. 4 and 5 show a boundary or flagging tape 60. The boundary tape 60 is extruded as a sheet material and wound on a spool 64 to create roll 62. The bioplastic material is printable so that warning messages may be applied to the tape 60.

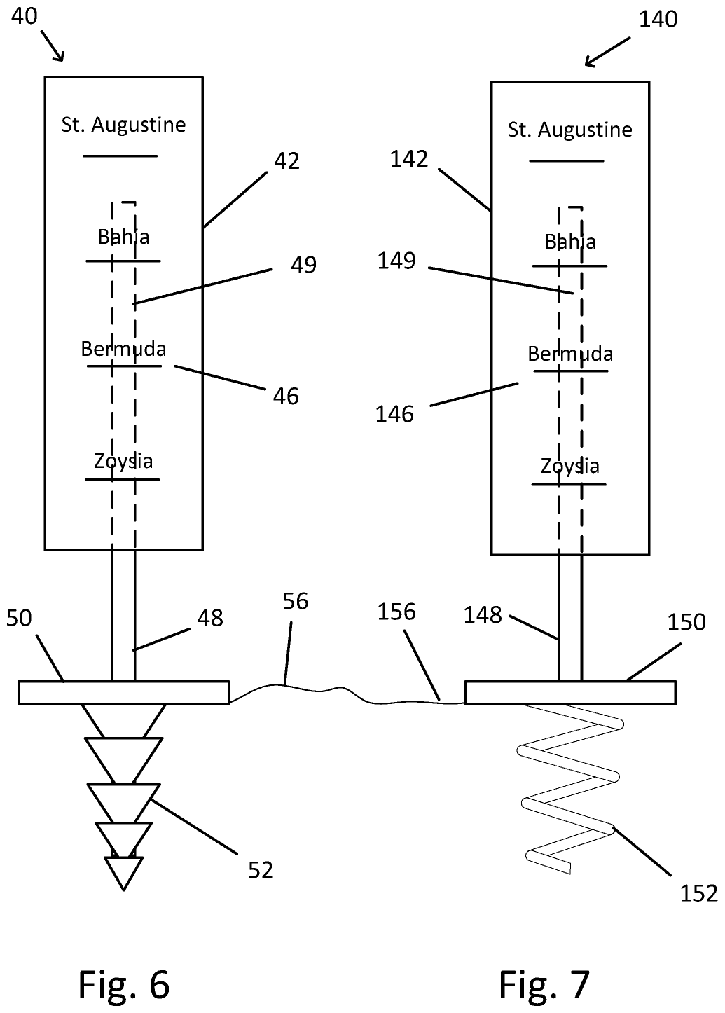

FIG. 6 shows a first embodiment of a grass depth gauge 40. The depth gauge 40 includes a stake 48 with an upper portion 49. A spike anchor 52 is located at the lower end of the stake 48, and a ground stop 50 is located above the spike anchor 52 to assure that the stake 48 is inserted in the ground 56 to a predetermined depth. In the first embodiment of the depth gauge 40, the upper portion 49 of the stake 48 above the ground 56 has a sleeve 42 that fits over the upper portion 49 of the stake 48 and includes indices 46 indicating the distance above the ground 56. The sleeve may be either paper or the bioplastic material. When a mower runs over the depth gauge 40, the sleeve 42 and part of the stake 48 are cut off. The remaining part of the sleeve 42 with its indices 46 informs yard maintenance personnel of the length of grass that the mower has left standing. Because all the portions of the depth gauge 40 are biodegradable, the depth gauge 40 can simply be left behind to degrade in the ground 56.

FIG. 7 shows a second embodiment of the grass depth gauge 140. The depth gauge 140 includes a stake 148 with an upper portion 149. A spiral anchor 152 is located at the lower end of the stake 148, and a ground stop 150 is located above the spiral anchor 152 to assure that the stake 148 is inserted in the ground 156 to a predetermined depth. In the second embodiment of the depth gauge 140, the upper portion 149 of the stake 148 above the ground 156 has a sleeve 142 that fits over the upper portion 149 of the stake 148 and includes indices 146 indicating the distance above the ground 156. The sleeve may be either paper or the bioplastic material. When a mower runs over the depth gauge 140, the sleeve 142 and part of the stake 148 are cut off. The remaining part of the sleeve 142 with its indices 146 informs yard maintenance personnel of the length of grass that the mower has left standing. Because all the portions of the depth gauge 140 are biodegradable, the depth gauge 140 can simply be left behind to degrade in the soil.

While this invention has been described with reference to preferred embodiments thereof, it is to be understood that variations and modifications can be affected within the spirit and scope of the invention as described herein and as described in the appended claims.

We claim:

1. A biodegradable marker flag for insertion into ground for marking a spot comprising:
an elongated biodegradable stake; and
a biodegradable sheet attached to the stake,
wherein the stake and the sheet are both formed of a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.

2. A biodegradable yard sign for displaying information comprising:
one or more elongated biodegradable stakes; and
a biodegradable sheet attached to the stakes,
wherein the one or more stakes and the sheet are both formed of a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.

3. A biodegradable yard sign for displaying information comprising:
a bent biodegradable stake; and
a biodegradable sleeve disposed over the bent stake,
wherein the stake and the sleeve are both formed of a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.

4. A biodegradable boundary tape to indicate the boundary of an area comprising:
a biodegradable printable tape,
wherein the tape is formed of a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.

5. A biodegradable grass depth gauge for insertion into ground for determining the height of mowed grass comprising:
an elongated biodegradable stake including;
an anchor at a lower end for penetrating the ground and securing the stake in place;
height indicia at an upper end for showing the height of mowed grass; and
a stop affixed to the stake above the anchor to establish a predetermined depth in the ground for the anchor,
wherein the stake is formed of a bioplastic material comprising a biodegradable aliphatic polyester produced from diacids selected from the group consisting of adipic acid and succinic acid, and combinations thereof and diol monomers selected from the group consisting of ethylene glycol, propanediol, butanediol, and hexanediol, and an effective amount of melt strength enhancer.
